(19) United States
(12) Patent Application Publication
(10) Pub. No.: US 2014/0335434 A1
(43) Pub. Date: Nov. 13, 2014

(54) FUEL CELL VEHICLE

(71) Applicants: Kengo Ikeya, Hamamatsu-shi (JP); Shiro Matsumoto, Hamamatsu-shi (JP); Naoki Ozawa, Hamamatsu-shi (JP); Yuuichi Umezane, Hamamatsu-shi (JP)

(72) Inventors: Kengo Ikeya, Hamamatsu-shi (JP); Shiro Matsumoto, Hamamatsu-shi (JP); Naoki Ozawa, Hamamatsu-shi (JP); Yuuichi Umezane, Hamamatsu-shi (JP)

(73) Assignee: SUZUKI MOTOR CORPORATION, Hamamatsu-shi, Shizuoka-ken (JP)

(21) Appl. No.: 14/119,030

(22) PCT Filed: Jul. 17, 2012
(86) PCT No.: PCT/JP2012/068061

§ 371 Date: Nov. 20, 2013

(30) Foreign Application Priority Data
Jan. 27, 2012 (JP) 2012-015268

(51) Int. Cl. H01M 8/04; B60L 11/18

(52) U.S. Cl. CPC H01M 8/04067; B60L 11/1892; H01M 2250/20
USPC 429/435

(57) ABSTRACT

A fuel cell vehicle is provided which includes an exterior heat exchanger for cooling and the exterior heat exchanger for heating are arranged at a front part of the vehicle, and the exterior heat exchanger for heating is heated by the outside air used to cool the air-cooling type fuel cell stack, an intake duct and an exhaust duct are mounted at the front side and the rear side of the air-cooling type fuel cell stack, respectively, the intake duct and the exterior heat exchanger for cooling are arranged at a front side part of the vehicle so as not to overlap with each other when the vehicle is seen from the front, and the exterior heat exchanger for heating is arranged at the rear of the exhaust duct.

### TECHNICAL FIELD

The present invention relates to a fuel cell vehicle, and in particular, relates to a fuel cell vehicle in which an air-cooling type fuel cell stack and a heat-pump type air-conditioning device are mounted, and in which improvement of air-conditioning performance and improvement of operability of the air-cooling type fuel cell stack are realized.

### BACKGROUND ART

In a fuel cell device, electricity is generated by a chemical reaction between hydrogen and oxygen in the air, and water is generated at the same time.

In the fuel cell reaction, various losses, including resistance overvoltage caused by electric resistance of a electrolytic film or an electrode inside the fuel cell stack, activation overvoltage for generating an electrochemical reaction between hydrogen and oxygen, diffusion overvoltage due to movement of hydrogen and oxygen in a diffusion layer and the like occur, and waste heat generated thereby must be removed.

The fuel cell devices include a water-cooling type fuel cell device for removing heat generated in power generation with cooling water and air-cooling type fuel cell device for cooling with air.

### CITATION LIST

### Patent Literature

[PTL 1] Japanese Unexamined Patent Application Publication No. 2000-301935
[PTL 2] Japanese Unexamined Patent Application Publication No. 2004-42759

### Summary of Invention

### Technical Problem

Heretofore, since a fuel cell stack of a fuel cell device mounted in a fuel cell vehicle has a heat generation amount that is less than that of an internal combustion engine, it has been inconvenient when a sufficient amount of heat cannot be obtained to heat the inside of a cabin.

Thus, as in PTL 1 or PTL 2, a heat-pump-type air-conditioning device which pumps heat from the outside air can be used in a vehicle in which a heat source cannot be reliably ensured.

PTL 1 describes a structure in which two units of exterior heat exchangers of the heat-pump-type air-conditioning device are arranged at the front and rear of an air flow direction of a heat generating source, and a channel of a refrigerant is switched so that the refrigerant is circulated to the exterior heat exchanger arranged at the rear side of the heat generating source during a heating operation, while the refrigerant is circulated to the exterior heat exchanger arranged at the front side of the heat generating source during cooling.

According to this structure of PTL 1, adhesion of frost to the vehicle exterior heat exchanger can be suppressed by allowing outside air at a relatively high temperature, having passed through the heat generating source during heating to flow through the vehicle exterior heat exchanger, while cooling performance can be improved by allowing outside air at a relatively low temperature before passing through the heat generating source to flow to the vehicle exterior heat exchanger during cooling.

PTL 2 describes that, in a vehicle provided with an engine or a fuel cell device and a heat-pump type air-conditioning device, two units of radiators for cooling the engine or the fuel cell device are arranged at the front and rear of the vehicle exterior heat exchanger of the heat-pump type air-conditioning device, and cooling water is made to flow to the radiator at the front side during heating, while the cooling water is made to flow to the radiator at the rear side during cooling so that refrigerant circulation amounts during cooling and heating are leveled while the effect similar to that in PTL 1 is obtained.

However, since the structures described in PTL 1 and PTL 2 have three heat exchangers juxtaposed in the longitudinal direction of the vehicle, it is inconvenient that an air amount of the outside air passing through the heat exchanger is reduced by an increase in ventilation resistance, and radiation performance of each heat exchanger deteriorates.

Moreover, in the structures described in PTL 1 and PTL 2, the engine or the fuel cell device assumes the water-cooling type in which cooling water is circulated therethrough, and if the water-cooling type is used for the air-cooling type fuel cell device using the outside air as a reaction gas and cooling medium, a temperature of the reaction gas is raised during cooling, which may lead to an inconvenience in that the amount of power generated fluctuates.

The present invention has an object to improve air-conditioning performance and to improve operability of the air-cooling type fuel cell stack in the fuel cell vehicle on which the air-cooling type fuel cell stack and the heat-pump-type air-conditioning device are mounted.

### Solution to Problem

Thus, in the present invention, in order to overcome the above-described inconveniences, a vehicle is provided with an air-cooling-type fuel cell stack using the outside air as a reaction gas and cooling medium and a heat-pump-type air-conditioning device, and the heat-pump type air-conditioning device includes, in this order, in a refrigerant circulation channel for circulating a refrigerant, a compressor for compressing the refrigerant, an indoor heat exchanger for performing heat exchange between the refrigerant and the air in a cabin, an expansion valve for expanding the refrigerant, and an exterior heat exchanger arranged for performing heat exchange between the refrigerant and the outside air, the flow of the refrigerant switched between in a cooling direction and in a heating direction, the exterior heat exchanger includes an exterior heat exchanger for cooling in which the refrigerant is circulated only during cooling and an exterior heat exchanger for heating in which the refrigerant is circulated only during heating, the air-cooling-type fuel cell stack, the exterior heat exchanger for cooling, and the exterior heat exchanger for heating are arranged at a front part of the vehicle, and the exterior heat exchanger for heating is heated by the outside air used to cool the air-cooling-type fuel cell stack, an intake duct and an exhaust duct are mounted at the front side and the rear side of the air-cooling type fuel cell stack, respectively, the intake duct and the exterior heat exchanger for cooling are arranged at the front side part of the vehicle so as not to overlap with each other in the vehicle longitudinal direction when the vehicle is seen from the front, and the exterior heat exchanger for heating is arranged at the rear of the exhaust duct.

### Advantageous Effects of Invention

As described above in detail, according to the present invention, the exterior heat exchanger for heating can be heated by outside air of which the temperature has been raised by heat exchange with the air-cooling type fuel cell stack during heating, and the heating performance of the heat-pump type air-conditioning device can be improved, and adhesion of frost to the exterior heat exchanger for heating can be prevented.

At this time, when the vehicle is seen from the front, since the intake duct and the exterior heat exchanger for cooling are arranged at the front side part of the vehicle in a state not overlapping in the vehicle longitudinal direction, a decrease of a flow rate of the outside air flowing to the exterior heat exchanger for heating through the intake duct due to ventilation resistance of the exterior heat exchanger for cooling can be prevented.

Thus, a radiation effect in the air-cooling type fuel cell stack and a heating effect in the exterior heat exchanger for heating are improved, and heating performance of the heat-pump type air-conditioning device can be improved.

Moreover, during cooling, a decrease of the flow rate of the outside air passing through the exterior heat exchanger for cooling due to the ventilation resistance of the exterior heat exchanger for heating can be prevented, and the cooling performance of the heat-pump type air-conditioning device can be improved.

Furthermore, since the outside air of which the temperature has been raised by cooling the exterior heat exchanger for cooling during cooling does not flow into the air-cooling type fuel cell stack, a temperature change of the outside air which is a reaction gas can be suppressed.

Thus, in the present invention, the air conditioning performance of the heat-pump type air-conditioning device can be improved, and the operability of the air-cooling type fuel cell stack can be improved.

### BRIEF DESCRIPTION OF DRAWINGS

FIG. 1 is a plan view of a front part of a fuel cell vehicle (Example).

FIG. 2 is a perspective view of a state in which the front part of the fuel cell vehicle is seen from the front right (Example).

FIG. 3 is a perspective view of the fuel cell vehicle when seen from the right side (Example).

FIG. 4 is a front view of the front part of the fuel cell vehicle (Example).

FIG. 5 is a configuration diagram of an air-cooling type fuel cell system (Example).

FIG. 6 is a diagram illustrating a refrigerant channel during heating of a heat-pump type air-conditioning device (Example).

FIG. 7 is a diagram illustrating the refrigerant channel during cooling of a heat-pump type air-conditioning device (Example).

### DESCRIPTION OF EMBODIMENTS

An embodiment of the present invention will be described below in detail referring to the attached drawings.

### Example

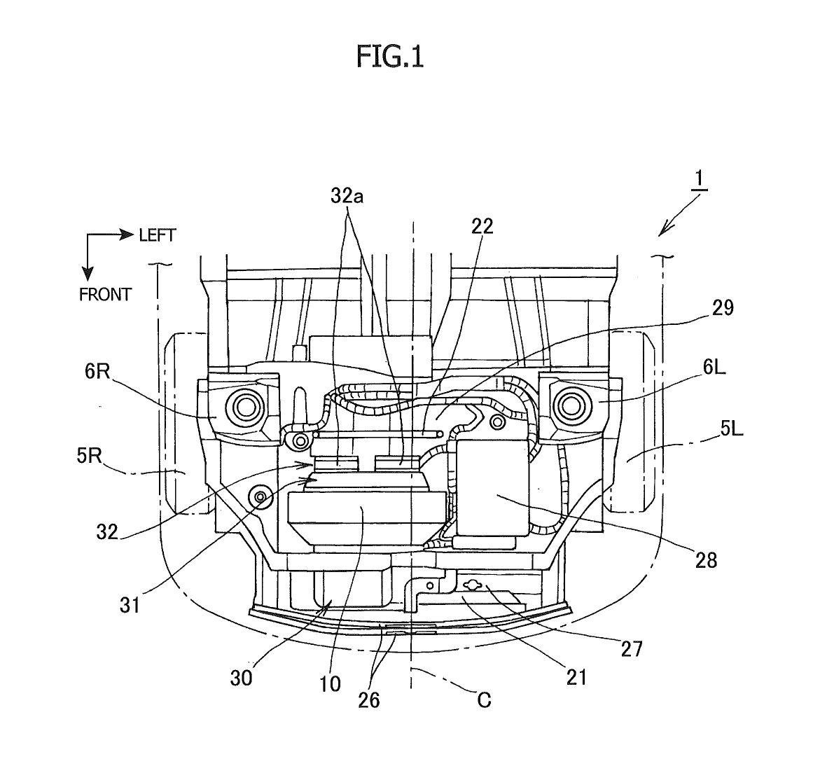

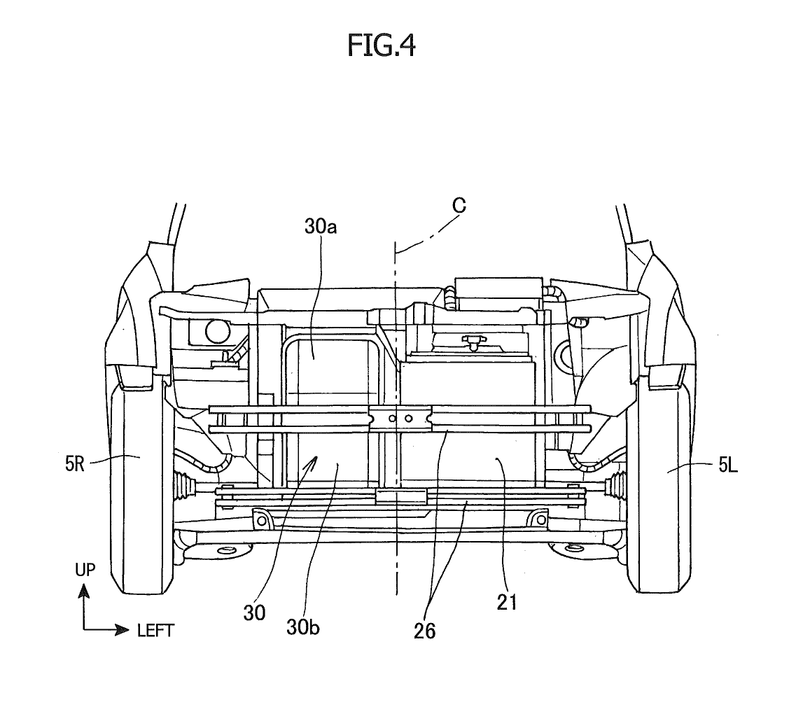

FIGS. 1 to 7 illustrate an example of the present invention.

In FIGS. 1 to 4, reference numeral 1 denotes a fuel cell vehicle, reference numeral 2 denotes a vehicle-body panel (also referred to as “front hood”), reference numeral 3 denotes a front windshield, reference numeral 4 denotes a dash panel, reference character 5L denotes a left front wheel, reference character 5R denotes a right front wheel, reference character 6L denotes a left side panel, and reference character 6R denotes a right side panel.

The fuel cell vehicle 1 has an air-cooling type fuel cell system 7 mounted thereon.

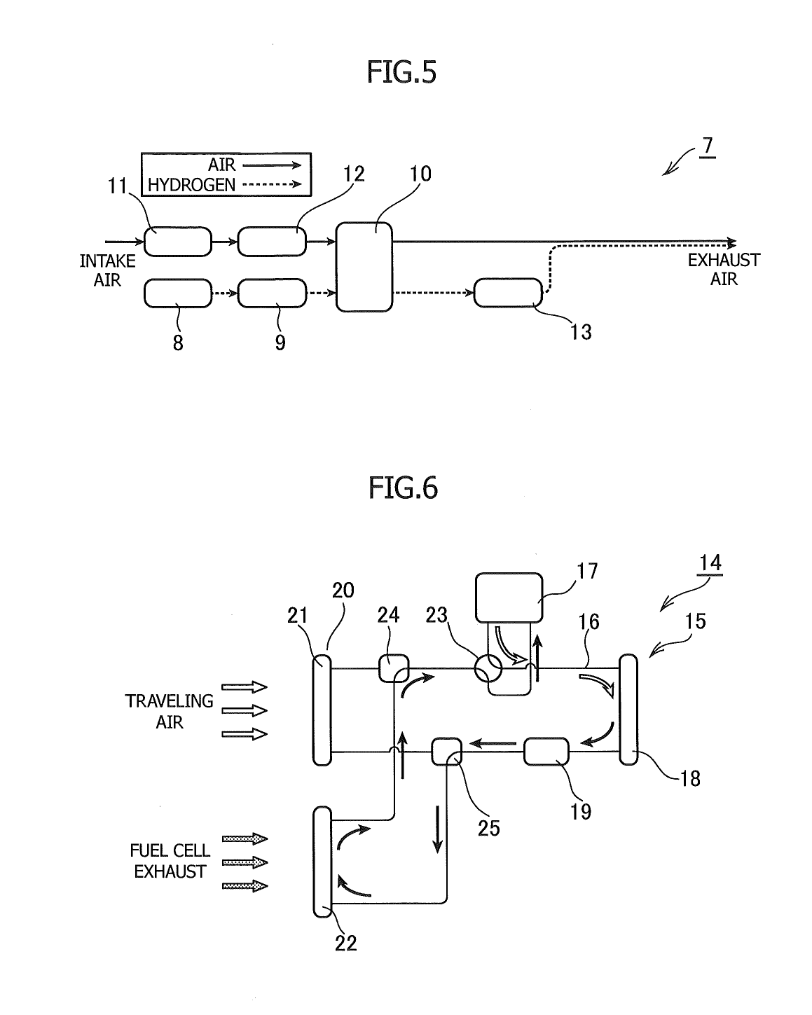

In this air-cooling type fuel cell system 7, as illustrated in FIG. 5, a high-pressure hydrogen gas stored in a hydrogen tank 8 in a compressed state is introduced into an anode intake portion of an air-cooling type fuel cell stack 10 after its pressure is reduced by a pressure-reducing valve 9, while an intake device for a cathode does not have a high-pressure compressor as in a general fuel cell device, and the outside air drawn through a filter 11 and is supplied to the air-cooling type fuel cell stack 10 by a low-pressure blower fan 12.

The air supplied to this air-cooling type fuel cell stack 10 is not only used in a power generation reaction (reaction gas) in the air-cooling type fuel cell stack 10, but also has a role in removing waste heat in the air-cooling type fuel cell stack 10 and cooling the air-cooling type fuel cell stack 10.

An anode exhaust passage of the air-cooling type fuel cell stack 10 is connected to a cathode exhaust passage from the air-cooling type fuel cell stack 10 through a purge valve 13, and when an exhaust hydrogen gas exhausted from the anode side is to be purged, the exhaust hydrogen gas is diluted to flammable lower-limit concentration or less and is emitted to the outside by the cathode side exhaust.

In this air-cooling type fuel cell system 7, an electrochemical reaction is performed, and water is generated thereby.

The air-cooling type fuel cell stack 10 is usually formed by laminating a large number of minimum constituent units called “cells”.

Since this air-cooling type fuel cell system 7 does not have a cooling-water loop as in the water-cooling type fuel cell device, heating by cooling water cannot be performed.

Subsequently, a heating and cooling system 14 for a fuel cell vehicle of the present invention will be described.

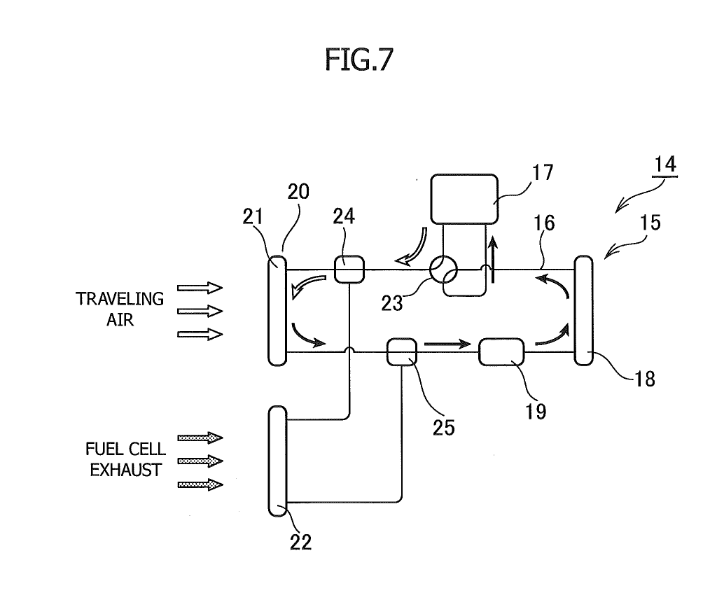

The heating and cooling system 14 for fuel cell vehicle mounted on the fuel cell vehicle 1 is provided with, as illustrated in FIGS. 6 and 7, a heat-pump type air-conditioning device (also referred to as “heat-pump type heating and cooling system”) 15.

This heat-pump type air-conditioning device 15 has, as illustrated in FIGS. 6 and 7, a compressor 17 for compressing a refrigerant, an indoor heat exchanger 18 for performing heat exchange between the refrigerant and the air in a cabin, an expansion valve 19 for expanding the refrigerant, and an exterior heat exchanger 20 for performing heat exchange between the refrigerant and the outside air, arranged in this order, in a refrigerant circulation channel 16 in which the refrigerant is circulated, and the flow of the refrigerant is switched between in a cooling direction and a heating direction.

Moreover, the exterior heat exchanger 20 includes an exterior heat exchanger 21 for cooling in which the refrigerant circulates only during cooling and an exterior heat exchanger 22 for heating in which the refrigerant circulates only during heating.

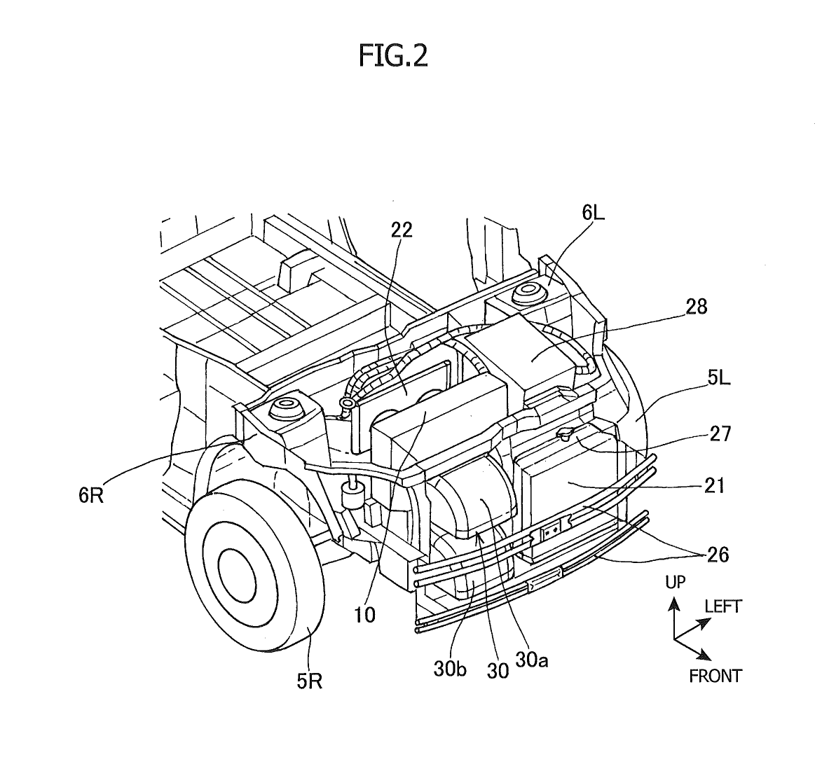

At this time, as illustrated in FIGS. 1 and 2, the fuel cell vehicle 1 has the air-cooling type fuel cell stack 10, the exterior heat exchanger 21 for cooling, and the exterior heat exchanger 22 for heating arranged on a front part in the vehicle and is configured such that the exterior heat exchanger 22 for heating is heated by the outside air used to cool the air-cooling type fuel cell stack 10.

That is, during heating of the heat-pump type air-conditioning device 15, as illustrated in FIG. 6, the cathode exhaust from the air-cooling type fuel cell system 7 is circulated only in the exterior heat exchanger 22 for heating.

At this time, a temperature of the cathode exhaust from the air-cooling type fuel cell system 7 is lower than a cooling water temperature of the internal combustion engine, but is sufficiently higher than the outside air temperature during heating.

Therefore, by leading the cathode exhaust from the air-cooling type fuel cell system 7 to the exterior heat exchanger 22 for heating, the refrigerant is further heated, and adhesion of frost to the exterior heat exchanger 22 for heating is prevented, and heating performance is improved.

Due to the recent development of power electronics technology, an electric vehicle including the fuel cell vehicle 1 generates an extremely small amount of heat due to losses from a motor, an inverter or the like, but the amount of waste heat from the fuel cell system is relatively greater, and thus, the effect of recovering the cathode waste heat of the air-cooling type fuel cell system 7 by the exterior heat exchanger 22 for heating is extremely large.

On the other hand, during cooling of the heat-pump type air-conditioning device 15, as illustrated in FIG. 7, introduction of the cathode exhaust from the air-cooling type fuel cell system 7 at a temperature higher than the outside air temperature to the exterior heat exchanger 22 for heating of the heat-pump type air-conditioning device 15 leads to deterioration of the cooling performance.

Thus, in an example of the present invention, the refrigerant circulation channel 16 is switched by first to third switching valves 23, 24, and 25 during cooling so that the refrigerant is circulated through the exterior heat exchanger 21 for cooling.

Into this exterior heat exchanger 21 for cooling, the outside air (traveling air) is introduced as in the past.

As described above, by providing the plurality of exterior heat exchangers, that is, the exterior heat exchanger 21 for cooling and the exterior heat exchanger 22 for heating in the heat-pump type air-conditioning device 15 and by switching the refrigerant circulation channel 16 in accordance with the state of the cooling and heating, prevention of frost formation and improvement of heating performance in the exterior heat exchanger during heating and improvement of cooling performance during cooling can both be realized.

Here, a structure of the front part of the fuel cell vehicle 1 will be described.

First, in the front part of the fuel cell vehicle 1, as illustrated in FIGS. 1 to 4, the exterior heat exchanger 21 for cooling is disposed on the left side of a center line C in a vehicle width direction of this fuel cell vehicle 1 and also on the rear of a bumper member 26 at the front part, and a radiator (also referred to as “water-cooling heat exchanger”) 27 for cooling electric components is disposed on the rear of this exterior heat exchanger 21 for cooling.

At the rear of this radiator 27, an inverter 28 and a traveling motor 29 are disposed.

Moreover, the air-cooling type fuel cell stack 10 is disposed on the right side of the inverter 28.

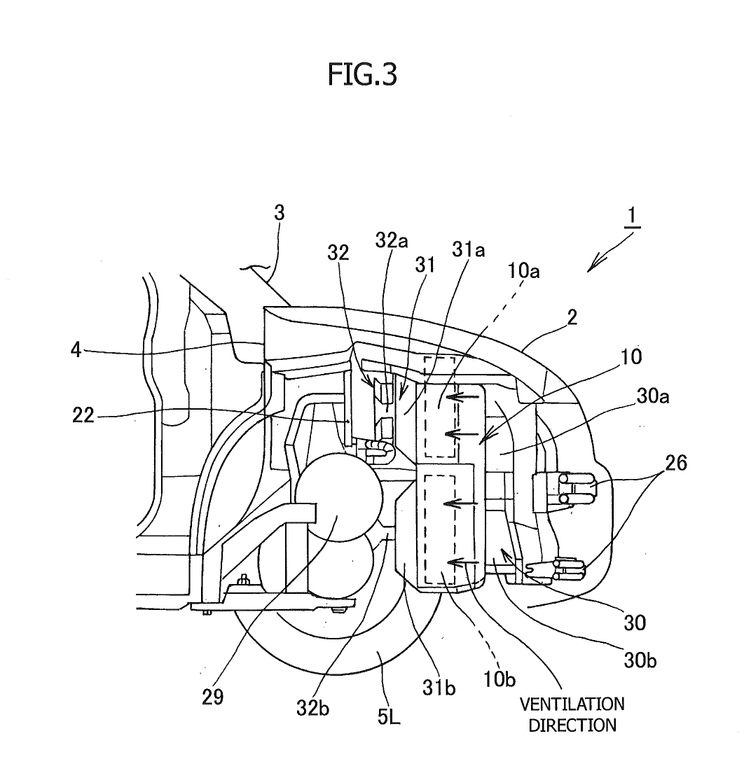

At this time, the air-cooling type fuel cell stack 10 is, as illustrated in FIG. 3, composed of a first fuel cell unit 10a and a second fuel cell unit 10b located below this first fuel cell unit 10a.

Then, an intake duct 30 and an exhaust duct 31 are mounted at the front side and the rear side of the air-cooling type fuel cell stack 10, respectively.

At this time, the intake duct 30 is composed of as illustrated in FIGS. 2 to 4, a first intake duct 30a located on the front side of the first fuel cell unit 10a above and a second intake duct 30b located below this first intake duct 30a and on the front side of the second fuel cell unit 10b.

Moreover, the exhaust duct 31 is, as illustrated in FIG. 3, composed of a first exhaust duct 31a located on the rear side of the first fuel cell unit 10a above and a second exhaust duct 31b located below this first exhaust duct 31a and at the rear side of the second fuel cell unit 10b.

At this time, when the fuel cell vehicle 1 is seen from the front, the intake duct 30 and the exterior heat exchanger 21 for cooling are arranged at the front side part of the vehicle so as not to overlap each other in the vehicle longitudinal direction, and the exterior heat exchanger 22 for heating is arranged at the rear of the exhaust duct 31 in the configuration.

In detail, at the front side part of the fuel cell vehicle 1, as illustrated in FIGS. 1, 2, and 4, when the exterior heat exchanger 21 for cooling is disposed at the left side of the vehicle width-direction center line C of the fuel cell vehicle 1 and also at the rear of the bumper member 26 at the front part, the intake duct 30 is disposed at the right side of the exterior heat exchanger 21 for cooling, that is, at the right side of the vehicle width-direction center line C of the fuel cell vehicle 1 and also at the rear of the bumper member 26 at the front part so that the intake duct 30 and the exterior heat exchanger 21 for cooling do not overlap each other in the vehicle longitudinal direction.

Moreover, on the rear of the exhaust duct 31 and in the vicinity of the disposed position of the traveling motor 29, as illustrated in FIGS. 1 to 3, the exterior heat exchanger 22 for heating is arranged.

Therefore, by means of the above-described structure, the exterior heat exchanger 22 for heating can be heated by outside air of which the temperature has been raised by heat exchange with the air-cooling type fuel cell stack 10 during heating, and the heating performance of the heat-pump type air-conditioning device 15 can be improved, and adhesion of frost to the exterior heat exchanger 22 for heating can be prevented.

At this time, when the fuel cell vehicle 1 is seen from the front, since the intake duct 30 and the exterior heat exchanger 21 for cooling are arranged on the front side part of the vehicle in the state not overlapped with each other in the vehicle longitudinal direction, a decrease of the flow rate of the outside air flowing to the exterior heat exchanger 22 for heating through the intake duct 30 due to the ventilation resistance of the exterior heat exchanger 21 for cooling can be prevented.

Thus, the radiation effect in the air-cooling type fuel cell stack 10 and the heating effect in the exterior heat exchanger 22 for heating are improved, and the heating performance of the heat-pump type air-conditioning device 15 can be improved.

Moreover, during cooling, a decrease of the flow rate of the outside air passing through the exterior heat exchanger 21 for cooling due to the ventilation resistance of the exterior heat exchanger 22 for heating can be prevented, and the cooling performance of the heat-pump type air-conditioning device 15 can be improved.

Furthermore, since the outside air, of which the temperature has been raised by cooling the exterior heat exchanger 21 for cooling does not flow into the air-cooling type fuel cell stack 10 during cooling, a temperature change of the outside air which is a reaction gas can be suppressed.

Thus, in the example of the present invention, the air-conditioning performance of the heat-pump type air-conditioning device 15 can be improved, and operability of the air-cooling type fuel cell stack 10 can be improved at the same time.

Moreover, the exterior heat exchanger 21 for cooling is arranged at a position closer to one side from the center part in the vehicle width direction or the vehicle vertical direction, and the intake duct 30 is arranged at a position closer to the other side from the center part in the vehicle width direction or the vehicle vertical direction.

That is, when the exterior heat exchanger 21 for cooling is arranged, as illustrated in FIGS. 1 and 2, it is arranged on the left side from the vehicle width-direction center line C of the fuel cell vehicle 1 and at a rear position of the bumper member 26 of the front part, and for example, at a position closer to the left side which is one side from the center part in the vehicle width direction.

Moreover, when the intake duct 30 is arranged, as illustrated in FIGS. 1, 2, and 4, it is arranged on the right side from the vehicle width-direction center line C of the fuel cell vehicle 1 and at a rear position of the bumper member 26 on the front side, and for example, at a position closer to the right side which is the other side from the center part in the vehicle width direction.

As a result, since the exterior heat exchanger 21 for cooling and the intake duct 30 are moved in the directions opposite to each other from the center part in the vehicle width direction or the vehicle vertical direction, or in the explanation of this example, in the vehicle width direction, inflow of the outside air whose temperature has been raised by cooling the exterior heat exchanger 21 for cooling during cooling into the air-cooling type fuel cell stack 10 can be prevented without bending the intake duct 30 in a complicated way.

Moreover, an exhaust fan 32 is arranged between the air-cooling type fuel cell stack 10 and the exterior heat exchanger 22 for heating.

That is, between the air-cooling type fuel cell stack 10 located on the front part of the vehicle and the exterior heat exchanger 22 for heating located on the side closer to the rear of the vehicle than the exhaust duct 31 mounted on this air-cooling type fuel cell stack 10, the exhaust fan 32 is disposed as illustrated in FIGS. 1 and 3.

At this time, this exhaust fan 32 is composed of, as illustrated in FIG. 3, first exhaust fans 32a and 32a located on the rear of the first exhaust duct 31a of the exhaust duct 31 and disposed in parallel in the vehicle width direction and a second exhaust fan 32b located below the first exhaust fans 32a and 32a and located in the rear of the second exhaust duct 31b of the exhaust duct 31.

As a result, the outside air can be drawn out of the air-cooling type fuel cell stack 10 by the exhaust fan 32, and at the same time, the outside air, of which the temperature has been raised, can be fed into the exterior heat exchanger 22 for heating.

Thus, heating characteristics of the exterior heat exchanger 22 for heating can be improved, and heating performance of the fuel cell vehicle 1 in which the air-cooling type fuel cell stack 10 is mounted can be improved.

Furthermore, the exterior heat exchanger 22 for heating is arranged above the traveling motor 29.

That is, when the traveling motor 29 is disposed on the rear of the exhaust duct 31, the exterior heat exchanger 22 for heating is disposed above the traveling motor 29 as illustrated in FIG. 3.

As a result, the exterior heat exchanger 22 for heating located above can be heated by heat generated from the traveling motor 29 during heating, and heating performance of the heat-pump type air-conditioning device 15 can be improved.

Moreover, an increase of the ventilation resistance in the channel through which the outside air is made to flow to the exterior heat exchanger 22 for heating by the traveling motor 29 can be prevented, and heating characteristics of the exterior heat exchanger 22 for heating can be improved.

Moreover, the air-cooling type fuel cell stack 10 has a structure in which fuel cell units or, for example, the first and the second fuel cell units 10a and 10b totaling in two units are stacked in the vehicle vertical direction, and the exhaust duct 31 and the exhaust fan 32 are arranged individually at positions corresponding to the first and second fuel cell units 10a and 10b in the vehicle vertical direction.

That is, the air-cooling type fuel cell stack 10 is composed of as illustrated in FIG. 3, the first fuel cell unit 10a and the second fuel cell unit 10b located below this first fuel cell unit 10a, and the first exhaust duct 31a and the first exhaust fans 32a and 32a are disposed at positions corresponding to these first and second fuel cell units 10a and 10b, that is, in the rear of the first fuel cell unit 10a, whereas the second exhaust duct 31b and the second exhaust fan 32b are disposed on the rear of the second fuel cell unit 10b.

As a result, the outside air can be reliably guided to the exterior heat exchanger 22 for heating while the cooling effect of the first and second fuel cell units 10a and 10b, for example, stacked in the vehicle vertical direction by the arrangement method of the exhaust duct 31 and the exhaust fan 32, is improved.

In addition, the fuel cell vehicle 1 is provided with the air-cooling type fuel cell stack 10 of the air-cooling type fuel cell system 7 and the heat-pump type air-conditioning device 15.

In the air-cooling type fuel cell system 7, with respect to the air-cooling type fuel cell stack 10 composed of the two fuel cell units, that is, the first and second fuel cell units 10a and 10b on the upper and lower sides, respectively, the intake duct 30 composed of the first and second intake ducts 30a and 30b, the exhaust duct 31 composed of the first and second exhaust ducts 31a and 31b, and the exhaust fan 32 composed of the first and second exhaust fans 32a, 32a, and 32b are provided, respectively.

At this time, this exhaust fan 32 is provided on the rear of the first and second fuel cell units 10a and 10b of the air-cooling type fuel cell stack 10 through the exhaust duct 31, and the exterior heat exchanger 22 for heating is arranged at the rear of the first and second exhaust fans 32a and 32a mounted at the first fuel cell unit 10a located on an upper part.

On the other hand, the exterior heat exchanger 21 for cooling is mounted on the side of the intake duct 30 in the front part of the vehicle and at a position where traveling air hits.

During heating, exhaust heat from the air-cooling type fuel cell system 7 is recovered in the exterior heat exchanger 22 for heating, while during cooling, the channel is switched so that the refrigerant passes through the exterior heat exchanger 21 for cooling.

At this time, the exterior heat exchanger 22 for heating is arranged on the rear of the air-cooling type fuel cell stack 10, and in this example, its lateral width is set to substantially equal to the length of the air-cooling type fuel cell stack 10 as illustrated in FIG. 1.

As a result, waste heat of the air-cooling type fuel cell stack 10 can be recovered efficiently.

Moreover, the exterior heat exchanger 22 for heating is arranged on the upper part of the traveling motor 29 in the rear of the air-cooling type fuel cell stack 10.

As a result, a space at the upper part of the traveling motor 29 can be used effectively, and since heated air can be collected easily, efficient heat recovery can be realized.

The arrangement structure of the exterior heat exchanger 21 for cooling and the exterior heat exchanger 22 for heating as in this example can be also employed even if the cooling method of the air-cooling type fuel cell stack 10 is a water-cooling type, but this is particularly effective heating means for the air-cooling type fuel cell system 7 which cannot use the cooling water for heating.

### REFERENCE SIGNS LIST

1 fuel cell vehicle
7 air-cooling type fuel cell system
8 hydrogen tank
9 pressure-reducing valve
10 air-cooling type fuel cell stack
11 filter
12 blower fan
13 purge valve
14 heating/cooling system for fuel cell vehicle
15 heat-pump type air-conditioning device (also referred to as “heat-pump type heating and cooling system”)
16 refrigerant circulation channel
17 compressor (also described as “compressor”)
18 indoor heat exchanger
19 expansion valve
20 exterior heat exchanger
21 exterior heat exchanger for cooling
22 exterior heat exchanger for heating
23, 24, 25 first to third switching valves
26 bumper member
27 radiator (also referred to as “heat exchanger for water cooling)
28 inverter
29 traveling motor
30 intake duct
31 exhaust duct
32 exhaust fan

1. A fuel cell vehicle comprising:
an air-cooling type fuel cell stack using outside air as a reaction gas and cooling medium; and
a heat-pump type air-conditioning device, including in this order in a refrigerant circulation channel for circulating a refrigerant,
a compressor for compressing the refrigerant,
an indoor heat exchanger for performing heat exchange between the refrigerant and air in a cabin,
an expansion valve for expanding the refrigerant; and
an exterior heat exchanger for performing heat exchange between the refrigerant and the outside air;
the flow of the refrigerant being switched between in a cooling direction and a heating direction;
the exterior heat exchanger including an exterior heat exchanger for cooling in which the refrigerant is circulated only during cooling and an exterior heat exchanger for heating in which the refrigerant is circulated only during heating; and
the air-cooling type fuel cell stack, the exterior heat exchanger for cooling, and the exterior heat exchanger for heating being arranged on a front part of the vehicle; and
the exterior heat exchanger for heating being heated by the outside air used to cool the air-cooling type fuel cell stack, wherein
an intake duct and an exhaust duct are mounted on the front side and the rear side of the air-cooling type fuel cell stack, respectively;
the intake duct and the exterior heat exchanger for cooling are arranged at a front side part of the vehicle so as not to overlap with each other in a vehicle longitudinal direction when the vehicle is seen from the front; and
the exterior heat exchanger for heating is arranged at the rear of the exhaust duct.

2. The fuel cell vehicle according to claim 1, wherein
the exterior heat exchanger for cooling is arranged at a position closer to one side from a center part in a vehicle width direction or a vehicle vertical direction, and the intake duct is arranged at a position closer to the other side from the center part in the vehicle width direction or the vehicle vertical direction.

3. The fuel cell vehicle according to claim 1, wherein
an exhaust fan is arranged between the air-cooling type fuel cell stack and the exterior heat exchanger for heating.

4. The fuel cell vehicle according to claim 1, wherein
the exterior heat exchanger for heating is arranged above a traveling motor.

5. The fuel cell vehicle according to claim 4, wherein
the air-cooling type fuel cell stack has a structure in which a plurality of fuel cell units are stacked in the vehicle vertical direction, and the exhaust duct and the exhaust fan are individually arranged at positions corresponding to each of the fuel cell units in the vehicle vertical direction.
